(19) United States
(12) Patent Application Publication
(10) Pub. No.: US 2025/0196696 A1
(43) Pub. Date: Jun. 19, 2025

(54) Vehicle Recognition for the Purpose of Providing Billing Information

(71) Applicant: Jörg Salomon, Bonn (DE)

(72) Inventor: Jörg Salomon, Bonn (DE)

(73) Assignee: Deutsche Post AG, Bonn (DE)

(21) Appl. No.: 18/983,592

(22) Filed: Dec. 17, 2024

(30) Foreign Application Priority Data
Dec. 18, 2023 (DE) 10 2023 135 445.0

(51) Int. Cl. B60L 53/66; B60L 53/62; B60L 53/65; G06Q 30/04; G06Q 50/06

(52) U.S. Cl. CPC B60L 53/665; B60L 53/62; B60L 53/65; G06Q 30/04; G06Q 50/06

(57) ABSTRACT

An apparatus includes means configured to obtain charging information. The charging information indicates an electrical energy transferred from a charging apparatus to a vehicle. The means are configured to obtain a first vehicle identifier that identifies the vehicle. The means are configured to provide billing information when it is determined that the first vehicle identifier matches a second vehicle identifier. The billing information represents at least the electrical energy transferred to the vehicle.

### CROSS-REFERENCE TO RELATED PATENT APPLICATIONS

This patent application claims the benefit of priority to German Patent Application No. 10 2023 135 445.0, filed Dec. 18, 2023, the entire teachings and disclosures are incorporated herein by reference thereto.

### TECHNICAL FIELD

Exemplary embodiments of the present disclosure concern, inter alia, an apparatus, a method and a computer program for obtaining a first vehicle identifier that identifies a vehicle (for example an electric vehicle). Here, the first vehicle identifier is taken as a basis for providing billing information representing at least one electrical energy transferred from a charging apparatus to the vehicle.

### BACKGROUND

In the field of electromobility, for example, it may be advantageous in a process of charging an electric vehicle at a charging station for the accrued energy costs to be able to be communicated and billed flexibly, for example depending on the vehicle or user in question. However, there are various technical challenges in this regard, for example if a certain charging apparatus does not have the necessary technical equipment to recognize the vehicle to be charged. In addition, there is a need for security precautions in order to prevent cases of fraud when billing the energy costs.

### SUMMARY OF EXEMPLARY EMBODIMENTS OF THE PRESENT DISCLOSURE

The present disclosure therefore set itself the object, inter alia, of simplifying the detection of energy costs when charging a vehicle and, at the same time, enabling flexible and fraud-proof billing of the energy costs.

According to the present disclosure, what is disclosed is an apparatus, wherein the apparatus comprises means, and wherein the means are configured to:
Obtain charging information, wherein the charging information indicates an electrical energy transferred from a charging apparatus to a vehicle;
Obtain a first vehicle identifier that identifies the vehicle;
Provide billing information when it is determined that the first vehicle identifier matches a second vehicle identifier, wherein the billing information represents at least the electrical energy transferred to the vehicle.

According to the present disclosure, what is further disclosed is a method, wherein the method comprises the following steps:
Obtaining charging information, wherein the charging information indicates an electrical energy transferred from a charging apparatus to a vehicle;
Obtaining a first vehicle identifier that identifies the vehicle;
Providing billing information when it is determined that the first vehicle identifier matches a second vehicle identifier, wherein the billing information represents at least the electrical energy transferred to the vehicle.

For example, the apparatus according to the present disclosure is configured to perform and/or control the method according to the present disclosure, or the apparatus according to the present disclosure comprises respective means for performing and/or controlling the method according to the present disclosure. Here, either all of the steps of the method may be controlled, or all of the steps of the method may be performed, or one or more steps may be controlled and one or more steps may be performed. By way of example, one or more of the means may be formed by one or more processors.

In a further example, the apparatus according to the present disclosure is an apparatus comprising at least one processor and at least one memory that includes program code, wherein the memory and the program code are configured to cause an apparatus having the at least one processor to perform and/or control at least the method according to the present disclosure. Here, either all of the steps of the method may be controlled, or all of the steps of the method may be performed, or one or more steps may be controlled and one or more steps may be performed.

According to the present disclosure, what is further disclosed is a computer program, wherein the computer program comprises commands that cause an apparatus to perform the steps of the method according to the present disclosure. This may for example be the apparatus according to the present disclosure. In a further example, the computer program comprises program instructions that cause a processor to perform and/or control the method according to the present disclosure when the computer program runs on the processor. A processor should be understood to mean, inter alia, control units, microprocessors, microcontrol units such as microcontrollers, digital signal processors (DSP), application-specific integrated circuits (ASICs) or field-programmable gate arrays (FPGAs). Here, either all of the steps of the method may be controlled, or all of the steps of the method may be performed, or one or more steps may be controlled and one or more steps may be performed. The computer program may be distributable for example via a network such as the Internet, a telephone or mobile radio network and/or a local area network. The computer program may be at least partially software and/or firmware of a processor. It may equally be implemented at least partially as hardware. The computer program may be stored for example on a computer-readable storage medium, for example a magnetic, electrical, optical and/or other type of storage medium. The storage medium may be for example part of the processor, for example a (non-volatile or volatile) program memory of the processor or part thereof. The storage medium may be for example a substantive or physical storage medium.

For example, the charging apparatus is connected to the vehicle via a charging cable, wherein the charging cable for example comprises one or more cable sections that connect the charging apparatus to the vehicle. The apparatus according to the present disclosure may for example be connected to the cable sections of the charging cable, wherein the apparatus may additionally or alternatively be understood to be part of the charging cable. By way of example, a cable section of the charging cable connects the charging apparatus to the apparatus, and a further cable section connects the apparatus to the vehicle.

For example, electrical energy provided by the charging apparatus is transferred to the vehicle via a charging cable. The vehicle may be understood to be an electric vehicle having an electric drive (for example a motor vehicle driven by a purely electric drive or partially electric drive), wherein the electrical energy for the drive is provided for example by one or more electric batteries of the vehicle. For example, a charging cable may accordingly be used to transfer electrical energy to the vehicle in order to charge the one or more batteries of the vehicle.

A charging apparatus is for example a charging station or part of a charging station that provides electrical energy for charging the battery of electric vehicles. By way of example, a charging apparatus may be understood to be a private charging station (for example a wallbox) that is designed for private use and is installed on a wall. As an alternative or in addition, a private charging station may be a power outlet (for example a high-voltage power outlet). In other examples, the charging apparatus is a public charging station (for example a fast-charging station).

For example, charging information may be understood to be electronically coded information indicating an electrical energy transferred from the charging apparatus to the vehicle. The charging information may in this case indicate the electrical energy, for example, as a numerical value in a physical unit (for example kWh). The charging information may for example be obtained (for example received) from an electricity meter that is part of the apparatus according to the present disclosure or is connected to this apparatus. For example, such an electricity meter is configured to detect (for example measure) the electrical energy transferred from the charging apparatus to the vehicle via a charging cable. This may be for example the electrical energy that is transferred from the charging apparatus to the vehicle during a specific charging process. The electricity meter for example takes the detected electrical energy as a basis for determining the charging information and transfers this charging information to the apparatus according to the present disclosure.

By way of example, a vehicle identifier should be understood to be electronically coded information based on which a vehicle is unambiguously identifiable. For example, the vehicle identifier represents (for example comprises) an identifier of a vehicle, wherein such an identifier may for example comprise a sequence of letters and/or numbers. By way of example, the vehicle identifier is a vehicle identification number, wherein the exact form of the vehicle identifier may depend on a protocol that is used. For example, in accordance with the ISO 15118 protocol, the first vehicle identifier may be the “Electric Vehicle Identifier (EVID)”.

For example, the first vehicle identifier is obtained (for example received) at the apparatus according to the present disclosure by virtue of the first vehicle identifier being transferred from the vehicle identified by the first vehicle identifier to the apparatus. By way of example, the first vehicle identifier may be transferred from the vehicle to the apparatus via a charging cable (for example via a cable section of the charging cable that connects the vehicle and the apparatus to one another).

For example, providing the billing information comprises determining (for example electronically generating) the billing information at least partially based on the previously obtained charging information. Accordingly, the billing information represents for example at least the electrical energy transferred from the charging apparatus to the vehicle and indicated by the previously obtained charging information. For this purpose, the billing information may for example indicate the electrical energy as a numerical value in a physical unit (for example kWh). In a further example, the billing information may indicate a cost amount (for example in EUR) that reflects the energy costs (for example electricity costs according to a specific electricity tariff) for the transferred electrical energy. The provided billing information may comprise further information or parameters, such as for example the previously obtained vehicle identifier or other parameters that concern for example a charging process between the charging apparatus and the vehicle.

For example, providing the billing information comprises transferring the billing information to a backend server at which the billing information is received and processed further (for example to enable reimbursement of the energy costs). For example, communication means (for example a mobile radio interface) of the apparatus according to the present disclosure may be used to transfer the billing information. A backend server is for example a management server at which billing information regarding a plurality of charging processes of a plurality of electric vehicles is obtained and managed. By way of example, there is a communication connection (for example a mobile radio connection) between the apparatus and the backend server via which the apparatus is able to transfer billing information to the backend server.

By way of example, if it is established that the first vehicle identifier does not match the second vehicle identifier, the billing information is not provided, for example. For example, in such a case, the billing information is not even determined in the first place, and in particular there is no transmission of billing information to a backend server. The energy costs for the transferred electrical energy, as indicated by the charging information, are then billed in a different way, for example, even though the charging apparatus is still able to be used to charge the battery of the vehicle. In particular, the energy costs are then not billed to the employee's company.

For example, the apparatus according to the present disclosure determines whether the obtained first vehicle identifier matches a second vehicle identifier that is stored in an electronic memory of the apparatus. Such a match may be present for example when the first vehicle identifier is the same as the second vehicle identifier or when the first vehicle identifier and the second vehicle identifier identify the same vehicle. If the first vehicle identifier matches the second vehicle identifier, the apparatus provides billing information, wherein the billing information represents at least the electrical energy transferred from the charging apparatus to the vehicle.

As an alternative or in addition, the determination whether the first vehicle identifier matches the second vehicle identifier may be performed on a backend server. In such an example, the apparatus, before providing billing information, for example transfers the obtained first vehicle identifier to the backend server, which compares the first vehicle identifier with a second vehicle identifier. For this purpose, the second vehicle identifier is stored for example in an electronic memory of the backend server. For example, after determining whether the first vehicle identifier matches the second vehicle identifier, information about whether the first vehicle identifier matches the second vehicle identifier is transferred from the backend server to the apparatus. By way of example, billing information is provided at the apparatus depending on this information.

For example, the second vehicle identifier identifies a specific vehicle for which separate billing of the electrical energy for charging a battery of this vehicle is permitted to be performed. For example, the second vehicle identifier may identify a specific vehicle of an employee of a company for which the employee is allowed to bill the costs of charging the electric battery of this vehicle to the company.

Advantageously, the apparatus according to the present disclosure makes it possible for example to limit billing of the electricity costs for charging the vehicle to the case in which such billing is also actually allowed for the vehicle. In such a case, the apparatus communicates for example with a backend server of the company so that the electricity costs are billed to said company. Otherwise, for example, no communication with the backend server and also no corresponding billing is performed, but the charging cable is advantageously still able to be used to charge the vehicle.

By way of example, recognizing the vehicle prevents cases of fraud in which an employee of a company attempts to bill the electricity costs for charging other vehicles, for which billing the electricity costs to the company is not allowed, to the company as well. In particular recognition accordingly takes place based on the vehicle and not for example based on the user.

The apparatus according to the present disclosure advantageously allows for example vehicle recognition for the purpose of billing regardless of whether the charging apparatus technically supports vehicle recognition. By way of example, the charging apparatus is a private charging station (for example an AC charging station or for example a power outlet) that for technical reasons does not support vehicle recognition because for example it does not, or not fully, support corresponding communication protocols (for example the ISO 15118 protocol) for communication between a charging station and a vehicle. The described use of the apparatus according to the present disclosure may advantageously enable recognition of a vehicle and targeted billing regardless of the respective technical design of the charging apparatus.

Further advantages of the exemplary aspects of the present disclosure are described below with reference to exemplary embodiments, the disclosure of which is intended to be equally applicable to the apparatus, the method and the computer program of the present disclosure.

In one exemplary embodiment, the means of the apparatus according to the present disclosure are further configured to determine whether the first vehicle identifier matches the second vehicle identifier.

As described above, the determination whether the first vehicle identifier matches the second vehicle identifier may be performed for example by the apparatus according to the present disclosure. This determination comprises for example the apparatus comparing the previously obtained first vehicle identifier with the second vehicle identifier, wherein the second vehicle identifier is stored in an electronic memory of the apparatus. For example, if such a comparison reveals that the first vehicle identifier is the same as the second vehicle identifier or that the first vehicle identifier and the second vehicle identifier identify the same vehicle, the apparatus determines that the first vehicle identifier matches the second vehicle identifier. In one example, a plurality of vehicle identifiers including the second vehicle identifier may be stored in an electronic memory of the apparatus, wherein the determination whether the first vehicle identifier matches the second vehicle identifier may comprise comparing the first vehicle identifier with at least one (for example with each) vehicle identifier of the plurality of vehicle identifiers. Such a comparison may for example reveal that a specific vehicle identifier of the plurality of vehicle identifiers matches the first vehicle identifier.

It may advantageously be determined, based on this comparison, whether the vehicle identified by the first vehicle identifier is allowed to bill the costs of charging the electric battery of this vehicle to a company, meaning that corresponding billing information needs to be provided.

In one exemplary embodiment according to the present disclosure, the billing information further identifies the vehicle, wherein billing of the electrical energy transferred to the vehicle is performed at least partially based on the vehicle identified by the billing information.

For example, the billing information comprises a parameter that specifies the electrical energy transferred from the charging apparatus to the vehicle as a numerical value in a physical unit (for example kWh), and also a further parameter that specifies an identifier of the vehicle based on which the vehicle is identifiable. By way of example, the billing information (for example represented by respective parameters) may comprise the first vehicle identifier and/or the second vehicle identifier. Based on the provided billing information, it is possible, for example i) to determine the electrical energy transferred from the charging apparatus to the vehicle and ii) to identify the vehicle to which the electrical energy has been transferred.

For example, billing of the electrical energy transferred to the vehicle is performed at least partially based on the vehicle identified by the billing information by virtue of the determination of energy costs for the electrical energy transferred to the vehicle depending at least partially on the vehicle identified by the billing information. If for example the billing information is transferred to a backend server in the course of the provision, the backend server is able to determine the transferred electrical energy and the vehicle based on the billing information. Based thereon, the backend server is for example able to determine energy costs for the transferred electrical energy (for example calculate electricity costs according to a specific electricity tariff), where these electricity costs depend on the identified vehicle. For example, an electricity tariff based on which the electricity costs for the transferred electrical energy are determined may be selected based on the identified vehicle.

Advantageously, the billing information may thereby be used for example to communicate what amount of electrical energy has been transferred to which vehicle within a certain charging process and should be billed accordingly. In this case, when calculating and/or billing energy costs, it is advantageously possible to distinguish between different vehicles and to perform individual billing depending on the vehicle in question.

In one exemplary embodiment according to the present disclosure, the apparatus further comprises storage means, wherein the storage means are configured to store a plurality of vehicle identifiers comprising the second vehicle identifier.

As described above, the second vehicle identifier identifies for example a specific vehicle for which separate billing of the electrical energy for charging a battery of this vehicle is permitted to be performed. For example, the second vehicle identifier may identify a specific vehicle of an employee of a company for which the employee is allowed to bill the costs of charging the electric battery of this vehicle to the company. Just like this second vehicle identifier, for example, each vehicle identifier of the plurality of vehicle identifiers may identify a respective vehicle for which separate billing of the electrical energy for charging a battery of the respective vehicle is permitted to be performed.

As part of the determination whether the first vehicle identifier matches the second vehicle identifier, for example, the first vehicle identifier may be compared with at least one (for example with each) vehicle identifier of the plurality of vehicle identifiers. By way of example, the vehicle identifiers of the plurality of vehicle identifiers may be compared individually with the first vehicle identifier in order to determine whether there is a match with the first vehicle identifier for a specific vehicle identifier. Such a comparison may for example reveal that a specific vehicle identifier of the plurality of vehicle identifiers, as second vehicle identifier, matches the first vehicle identifier.

Advantageously, the plurality of vehicle identifiers stored in the apparatus makes it possible, in the case of processes of charging different vehicles, to achieve, for multiple vehicles, individual billing of the electricity costs for charging these vehicles. In particular, it may be established, for a plurality of vehicles, whether separate billing of the electricity costs for charging these vehicles is allowed.

In one exemplary embodiment according to the present disclosure, the apparatus further comprises communication means, wherein the communication means are configured to transfer the provided billing information to a backend server.

For example, the apparatus according to the present disclosure comprises communication means that enable the transmission and/or reception of electronic information at the apparatus. By way of example, the communication means of the apparatus are configured to provide a communication connection between the apparatus and the backend server. For example, the communication means comprise a radio interface for communication in accordance with a mobile radio standard (for example the 3G, 4G or 5G standard) or in accordance with another wireless radio communication technology (for example Wi-Fi). As an alternative or in addition, the communication means comprise an interface for communication in accordance with a wired technology (for example USB or Ethernet).

A communication connection between the apparatus and the backend server is for example formed at least in parts as a wireless communication connection and is provided in this case via a mobile radio network. In another example, a communication connection between the apparatus and the backend server may also be an exclusively wired communication connection that for example transfers information from the apparatus first to the charging apparatus, and from the charging apparatus to the backend server (for example via a wired Internet cable between the backend server and a building in which the charging apparatus is located).

In one exemplary embodiment according to the present disclosure, the apparatus further comprises measuring means, wherein the measuring means are configured to detect the electrical energy transferred to the vehicle and to determine the charging information.

For example, the apparatus according to the present disclosure comprises measuring means that are able to determine electronic information (for example charging information) and then provide same to the apparatus. By way of example, the measuring means comprise an electricity meter that is configured to detect (for example measure) the electrical energy transferred from a charging apparatus to a vehicle via a charging cable. Such an electricity meter comprises for example multiple electronic components, such as a transducer, an analog-to-digital converter, a processor and/or an internal electronic memory.

In one exemplary embodiment according to the present disclosure, the apparatus further comprises connecting means, wherein the connecting means are configured to connect the apparatus to the vehicle and the apparatus to the charging apparatus.

For example, the connecting means of the apparatus according to the present disclosure may comprise one or more electric cables (for example electric charging cables for charging an electric vehicle) or comprise at least one or more cable sections of such an electric cable. Such cables or cable sections may for example electrically connect the apparatus to a vehicle and to a charging apparatus, such that electrical energy provided by the charging apparatus is able to be transferred to the vehicle.

In other examples, the connecting means may, in addition or as an alternative, comprise one or more plug connectors by way of which electric cables (for example a charging cable) are able to be connected to the apparatus and subsequently disconnected from the apparatus again. By way of example, plug connectors of the apparatus may be connected directly to the charging apparatus and/or directly to the vehicle (that is to say without the use of electric cables), such that the apparatus is able to be connected directly to a charging apparatus (or to a vehicle), for example by way of a plug connection, while a second plug connection of the apparatus connects the apparatus to the vehicle (or to the charging apparatus) by way of an electric cable.

For example, plug connectors of the connecting means are designed in accordance with a common plug type for the connection of electric vehicles to a charging apparatus (for example Type 1, Type 2, CHAdeMO or CCS). In other examples, the connecting means may also comprise other plug types for making an electrical connection (for example a Schuko Type F plug).

In one exemplary embodiment according to the present disclosure, the means of the apparatus are further configured to receive the first vehicle identifier from the vehicle.

For example, the apparatus according to the present disclosure receives the first vehicle identifier from the vehicle, wherein the first vehicle identifier identifies this vehicle. The first vehicle identifier is in this case transferred to the apparatus for example via a cable section of a charging cable that connects the apparatus to the vehicle. For example, this transfer may be performed in accordance with the ISO 15118 protocol, wherein the first vehicle identifier may for example be the “Electric Vehicle Identifier (EVID)”.

In one exemplary embodiment according to the present disclosure, the means of the apparatus are further configured to:
Obtain position information, wherein the position information indicates a position of the apparatus;
Determine whether the position of the apparatus is located within a predetermined position range; and
Provide the billing information when it is additionally determined that the position of the apparatus is located within a predetermined position range.

For example, the apparatus according to the present disclosure obtains the position information from a position sensor that is part of the apparatus or is connected to the apparatus. Such a position sensor may for example be a GPS sensor that detects a current position of the position sensor and thus of the apparatus and determines the position information based thereon, wherein the position information indicates the position of the apparatus, for example using multiple position coordinates.

The apparatus also determines for example whether the position of the apparatus as indicated by the previously obtained position information is located within a predetermined position range. For this purpose, for example, an electronic memory of the apparatus may store position coordinates that reflect the predetermined position range (for example a geographical area). For example, the position coordinates that reflect the predetermined range are compared with the position coordinates of the previously obtained position information.

As an alternative or in addition, the determination whether the position of the apparatus is located within a predetermined position range may be performed for example on the backend server. In such a case, the apparatus transfers for example the previously obtained position information to the backend server, which compares this position information with the predetermined position range. For example, for this purpose, position coordinates that reflect the predetermined position range are stored in an electronic memory of the backend server.

For example, billing information is then provided, as described above, (for example only) when the first vehicle identifier matches the second vehicle identifier and when the position of the apparatus is additionally located within a predetermined position range. A combination of these two conditions for the provision with further conditions is likewise conceivable.

The predetermined position range may in particular be understood to be a geographical area within which billing of the energy costs for charging the vehicle is allowed. This advantageously makes it possible for example to provide a further security feature in order to prevent cases of fraud involving unauthorized billing of electricity costs for charging electric vehicles to a company.

In one exemplary embodiment according to the present disclosure, the apparatus further comprises positioning means, wherein the positioning means are configured to detect the position of the apparatus and to determine the position information.

For example, the apparatus according to the present disclosure comprises positioning means that comprise for example one or more satellite positioning sensors (for example a GPS sensor) in order to detect the position coordinates of the apparatus at a certain time. As an alternative or in addition, the positioning means are able to determine a position of the apparatus for example by radio triangulation (for example based on mobile radio signals received by a radio interface of the apparatus).

In one exemplary embodiment according to the present disclosure, the means of the apparatus are further configured to:
Obtain a first charging apparatus identifier that identifies the charging apparatus; and
Provide the billing information when it is additionally determined that the first charging apparatus identifier matches a second charging apparatus identifier.

For example, the apparatus according to the present disclosure obtains a first charging apparatus identifier from the charging apparatus, wherein the first charging apparatus identifier identifies the charging apparatus. The first charging apparatus identifier is in this case transferred for example from the charging apparatus to the apparatus via a cable section of a charging cable. By way of example, the transfer may be performed in accordance with the ISO 15118 protocol, wherein the first charging apparatus identifier may be the “Charge Point Identifier (CPID)”. However, the transfer of the charging apparatus identifier is not tied to a specific protocol, meaning that for example the charging apparatus does not have to support the ISO 15118 protocol.

For example, billing information is then provided, as described above, (for example only) when the first vehicle identifier matches the second vehicle identifier and when the first charging apparatus identifier additionally matches a second charging apparatus identifier.

For example, the second charging apparatus identifier identifies a specific charging apparatus for which separate billing of the electrical energy for charging a battery of a vehicle is permitted to be performed. For example, the second charging apparatus identifier may identify a private charging station of an employee of a company for which the employee is allowed to have the costs of charging the electric battery of a vehicle billed to the company. This advantageously makes it possible for example to provide a further security feature in order to prevent cases of fraud involving unauthorized billing of electricity costs for charging electric vehicles to a company.

For example, a combination of multiple conditions for providing billing information is possible. By way of example, there may thus be a combination of conditions such that provision of billing information is performed (for example only) when i) the first vehicle identifier matches the second vehicle identifier, when ii) the position of the apparatus is additionally located within a predetermined position range and when iii) the first charging apparatus identifier additionally matches the second charging apparatus identifier. This advantageously makes it possible to further increase the security measures in order to prevent cases of fraud involving unauthorized billing of electricity costs for charging electric vehicles to a company.

In one exemplary embodiment according to the present disclosure, the means of the apparatus are further configured to determine whether the first charging apparatus identifier matches the second charging apparatus identifier.

For example, the apparatus according to the present disclosure determines whether a charging apparatus identifier obtained from the charging apparatus matches a second charging apparatus identifier that is stored in an electronic memory of the apparatus. Such a match is present for example when the first charging apparatus identifier is the same as the second charging apparatus identifier or when the first charging apparatus identifier and the second charging apparatus identifier identify the same charging apparatus. As an alternative or in addition, the determination whether the first charging apparatus identifier matches the second charging apparatus identifier may be performed for example on a backend server. In such an example, the apparatus transfers the obtained first charging apparatus identifier to the backend server, which compares the first charging apparatus identifier with a second charging apparatus identifier. For this purpose, the second charging apparatus identifier is stored for example in an electronic memory of the backend server.

In one exemplary embodiment according to the present disclosure, the apparatus further comprises storage means, wherein the storage means are configured to store a plurality of charging apparatus identifiers comprising the second charging apparatus identifier.

As described above, the second charging apparatus identifier identifies for example a specific charging apparatus for which separate billing of the electrical energy for charging a battery of a vehicle is permitted to be performed. For example, the second charging apparatus identifier may identify a private charging station of an employee of a company for which the employee is allowed to have the costs of charging the electric battery of a vehicle billed to the company. Just like this second charging apparatus identifier, for example, each charging apparatus identifier of the plurality of charging apparatus identifiers may identify a respective charging apparatus for which the employee is allowed to have the costs of charging the electric battery of a vehicle billed to the company.

As part of the determination whether the first charging apparatus identifier matches the second charging apparatus identifier, for example, the first charging apparatus identifier may be compared with at least one (for example with each) charging apparatus identifier of the plurality of charging apparatus identifiers. By way of example, the charging apparatus identifiers of the plurality of charging apparatus identifiers may be compared individually with the first charging apparatus identifier in order to determine whether there is a match with the first charging apparatus identifier for a specific charging apparatus identifier. Such a comparison may for example reveal that a specific charging apparatus identifier of the plurality of charging apparatus identifiers, as second charging apparatus identifier, matches the first charging apparatus identifier.

Advantageously, the plurality of charging apparatus identifiers, stored in the apparatus, for a plurality of charging apparatuses makes it possible to store, in the apparatus, the fact that separate billing of the electrical energy for charging a battery of a vehicle is permitted to be performed for charging processes using these charging apparatuses.

In one exemplary embodiment according to the present disclosure, the apparatus is at least part of a charging cable for charging an electrical storage unit of the vehicle, or is connectable to a charging cable for charging an electrical storage unit of the vehicle.

The apparatus according to the present disclosure is connectable for example to one or more cable sections (for example cable sections of a charging cable for electric vehicles). In another example, an entire charging cable comprising one or more cable sections may be understood to be an apparatus according to the present disclosure. In a further example, the apparatus according to the present disclosure may be understood to be a single electronic component that is part of a further apparatus (for example installed in a corresponding housing). It is also conceivable for the apparatus according to the present disclosure to be integrated into a charging cable for an electric vehicle, such that it is not recognizable for example outwardly as an apparatus.

The present disclosure further discloses a system, wherein such a system comprises at least the apparatus according to the present disclosure. The system may further comprise for example a charging apparatus, a vehicle, a backend server and/or a charging cable.

The above-described exemplary embodiments and exemplary configurations of the present disclosure should also be understood to be disclosed in all combinations with one another. In particular, the disclosure of a method step is also deemed to be disclosure of means for performing the respective method step. Likewise, the disclosure of means for performing a method step is also deemed to be disclosure of the method step itself.

Further advantageous exemplary configurations of the present disclosure may be gathered from the following detailed description of some exemplary embodiments, in particular in association with the figures. The accompanying figures are however only intended for the purpose of elucidation, but do not serve for determining the scope of protection of the claims. The accompanying drawings are not necessarily true to scale and are intended only to reflect the general concept of the present disclosure by way of example. In particular, features contained in the figures are in no way intended to be considered a necessary part of the present invention.

### BRIEF DESCRIPTION OF THE DRAWINGS

In the figures:

FIG. 1 shows a schematic illustration of one exemplary environment in which an apparatus according to the present disclosure is able to be used;

FIG. 2 shows a flowchart of one exemplary embodiment of a method according to the present disclosure;

FIG. 3 shows a flowchart of a further exemplary embodiment of a method according to the present disclosure;

FIG. 4 shows a flowchart of a further exemplary embodiment of a method according to the present disclosure;

FIG. 5 shows a schematic illustration of one exemplary embodiment of the apparatus according to the present disclosure; and

FIG. 6 shows exemplary embodiments of storage media.

### DETAILED DESCRIPTION OF SOME EXEMPLARY EMBODIMENTS

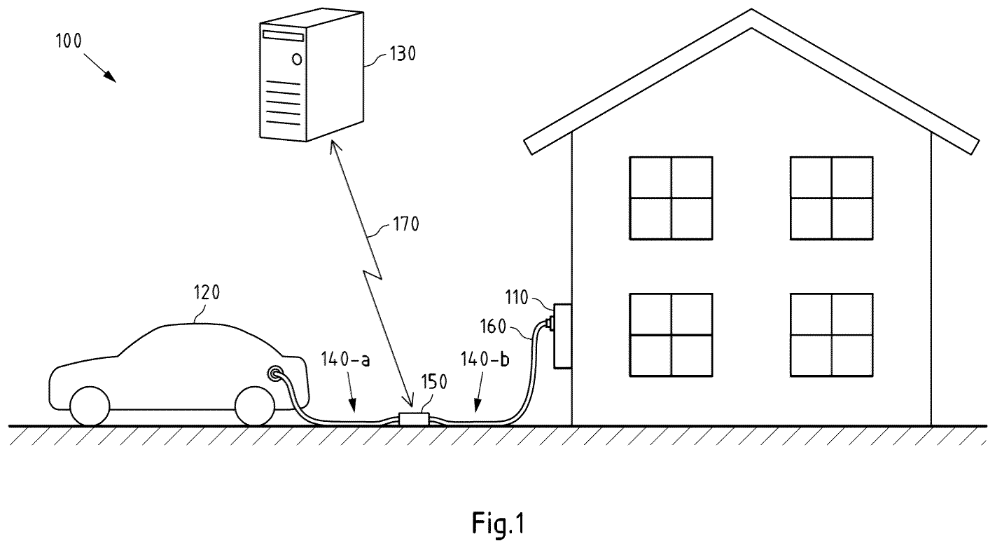

FIG. 1 shows a schematic illustration of one exemplary environment 100 in which an apparatus 150 according to the present disclosure is able to be used.

FIG. 1 shows a charging apparatus 110 that is connected to the vehicle 120 via a charging cable 160. The charging cable 160 consists for example of the cable sections 140a and 140b, which connect the apparatus 150 to the charging apparatus 110 and the vehicle 120. Also shown in FIG. 1 is a backend server 130 that is able to exchange information with the apparatus 150 via a communication path 170 (for example by way of a mobile radio network).

The apparatus 150 should be understood, by way of example, to be an apparatus according to the present disclosure, wherein the apparatus 150, as shown, is connectable to the two cable sections 140a, 140b. In another example, the entire charging cable 160 comprising the cable sections 140a, 140b and the apparatus 150 may be understood to be an apparatus according to the present disclosure. In a further example, the apparatus according to the present disclosure may be only part (for example a single electronic component, as illustrated schematically in FIG. 5 as an apparatus 50) of the apparatus 150. It is also conceivable for the apparatus 150 to be integrated into the charging cable 160, such that, unlike as illustrated by way of example in FIG. 1, it is not recognizable outwardly as an apparatus.

The charging apparatus 110 is shown, by way of example, as a charging station that provides electrical energy for charging the battery of electric vehicles. The charging apparatus 110 may be understood to be a private charging station (for example a wallbox or a power outlet, such as for example a high-voltage power outlet) that is designed for private use and is installed on a wall. In other examples, the charging apparatus 110 may be a public charging station (for example a fast-charging station).

The electrical energy provided by the charging apparatus 110 is transferred to the vehicle 120 via the charging cable 160. The vehicle 120 is shown, by way of example, as an electric vehicle having an electric drive, wherein the electrical energy for the drive is provided by one or more electric batteries of the vehicle 120. The charging cable 160 may accordingly be used to transfer electrical energy to the vehicle 120 in order to charge the one or more batteries of the vehicle 120.

The backend server 130 is for example a management server at which billing information regarding a plurality of charging processes of a plurality of electric vehicles is obtained and managed. As shown in FIG. 1 by way of example, there is a communication connection 170 between the apparatus 150 and the backend server 130 via which the apparatus 150 is able to transfer billing information to the backend server 130.

The communication connection 170 is for example formed at least in parts as a wireless communication connection and is provided in this case via a mobile radio network. In particular, the communication connection 170 uses the mobile radio infrastructure of a mobile radio network (for example one or more base stations) to transfer information from the apparatus 150 to the backend server 130 in accordance with a mobile radio standard (for example the 3G, 4G or 5G mobile radio standard). In another example, the communication connection 170 between the apparatus 150 and the backend server 130 may also be an exclusively wired communication connection that transfers information from the apparatus 150 first to the charging apparatus 110, and from the charging apparatus 110 to the backend server 130 (for example via a wired Internet cable between the backend server 130 and a building in which the charging apparatus 110 is located).

For the environment 100 shown by way of example, it may be assumed that the charging apparatus 110 is a private charging station that is installed for example at the dwelling of an employee of a company. In addition, the vehicle 120 may also be an electric vehicle of this employee (for example, the vehicle 120 is a company vehicle), wherein the employee is allowed to have the costs of charging the electric battery of this vehicle 120 (and for example not other vehicles) by way of the private charging station 110 billed to the company. Accordingly, for example, for charging processes of this vehicle 120 (and for example not for charging processes of other vehicles) at the charging apparatus 110, billing information representing the electrical energy transferred during a charging process is intended to be communicated to a backend server 130. By way of example, in this case, the backend server 130 is operated by the company.

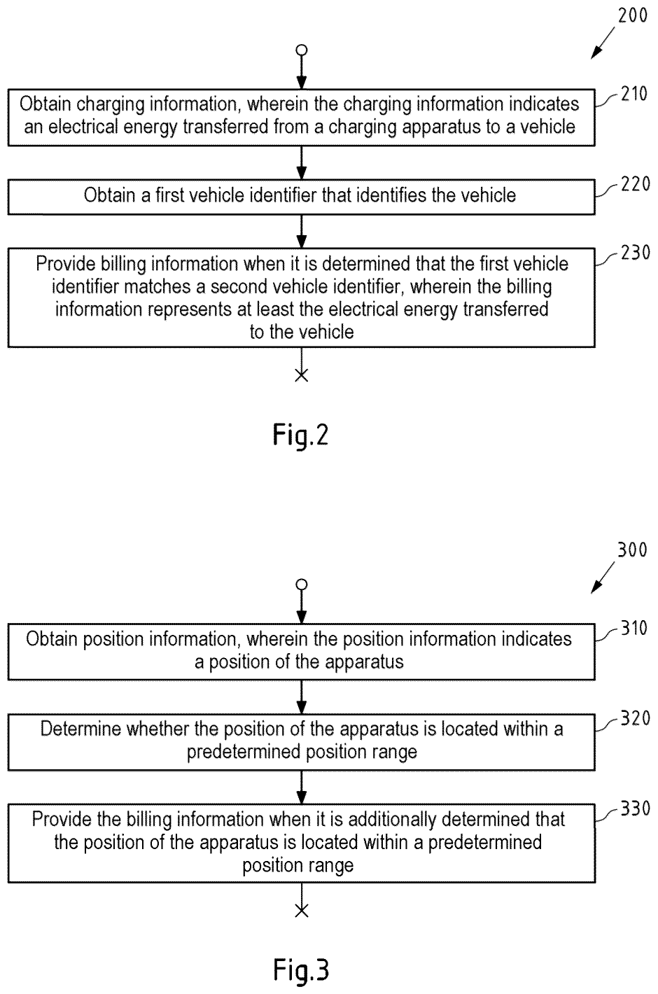

FIG. 2 shows a flowchart of one exemplary embodiment of a method 200 according to the present disclosure. Method steps 210, 220 and 230 are described below by way of example with reference to the environment 100 shown in FIG. 1. It is assumed here by way of example that method steps 210, 220 and 230 are performed by the apparatus 150.

Step 210 comprises obtaining charging information, wherein the charging information indicates an electrical energy transferred from a charging apparatus to a vehicle.

For example, in step 210, the apparatus 150 obtains the charging information from an electricity meter that is part of the apparatus 150 or is connected to the apparatus 150. Such an electricity meter is configured to detect (for example measure) the electrical energy transferred from the charging apparatus 110 to the vehicle 120 via the charging cable 160. This may be for example the electrical energy that is transferred from the charging apparatus 110 to the vehicle 120 during a certain charging process. The electricity meter for example takes the detected electrical energy as a basis for determining the charging information and transfers this charging information to the apparatus 150 in step 210.

The charging information obtained in step 210 should be understood to be electronically coded information that indicates the electrical energy measured by the electricity meter and thus indicates the electrical energy transferred from the charging apparatus 110 to the vehicle 120. The charging information may in this case indicate the electrical energy, for example, as a numerical value in a physical unit (for example kWh).

Step 220 comprises obtaining a first vehicle identifier that identifies the vehicle.

For example, in step 220, the apparatus 150 obtains the first vehicle identifier from the vehicle 120, wherein the first vehicle identifier identifies the vehicle 120. The first vehicle identifier is in this case transferred in particular to the apparatus 150 via the cable section 140a of the charging cable 160. By way of example, the transfer may be performed in accordance with the ISO 15118 protocol, wherein the first vehicle identifier may be the “Electric Vehicle Identifier (EVID)”. The vehicle identifier obtained in step 220 should be understood to be electronically coded information based on which the vehicle 120 is unambiguously identifiable.

Step 230 comprises providing billing information when it is determined that the first vehicle identifier matches a second vehicle identifier, wherein the billing information represents at least the electrical energy transferred to the vehicle.

For example, the apparatus 150 determines whether the first vehicle identifier obtained from the vehicle 120 in step 220 matches a second vehicle identifier that is stored in an electronic memory of the apparatus 150. Such a match may be present when the first vehicle identifier is the same as the second vehicle identifier or when the first vehicle identifier and the second vehicle identifier identify the same vehicle 120. If the first vehicle identifier matches the second vehicle identifier, the apparatus 150 provides billing information, wherein the billing information represents at least the electrical energy transferred from the charging apparatus 110 to the vehicle 120.

As an alternative or in addition, the determination whether the first vehicle identifier matches the second vehicle identifier may be performed on the backend server 130. In such a case, as part of step 230, the apparatus 150 for example transfers the first vehicle identifier obtained in step 220 to the backend server 130, which compares the first vehicle identifier with a second vehicle identifier. For this purpose, the second vehicle identifier is stored for example in an electronic memory of the backend server 130.

For example, the second vehicle identifier identifies a specific vehicle 120 for which separate billing of the electrical energy for charging a battery of this vehicle is permitted to be performed. According to the above description for FIG. 1, the second vehicle identifier may for example identify a specific vehicle 120 of an employee of a company for which the employee is allowed to bill the costs of charging the electric battery of this vehicle 120 to the company.

The provision of the billing information in step 230 comprises for example determining (for example electronically generating) the billing information at least partially based on the charging information obtained in step 210. Accordingly, the billing information represents at least the electrical energy transferred from the charging apparatus 110 to the vehicle 120 and indicated by the charging information obtained in step 210. For this purpose, the billing information may for example indicate the electrical energy as a numerical value in a physical unit (for example kWh). In a further example, the billing information may indicate a cost amount (for example in EUR) that reflects the energy costs (for example electricity costs according to a specific electricity tariff) for the transferred electrical energy. The billing information provided in step 230 may comprise further information or parameters, such as for example the vehicle identifier obtained in step 210 or other parameters that concern a charging process between the charging apparatus 110 and the vehicle 120.

The provision of the billing information in step 230 comprises for example transferring the billing information, via the communication connection 170, to the backend server 130, at which the billing information is further processed (for example to enable reimbursement of the energy costs). For this purpose, communication means (for example a mobile radio interface) of the apparatus 150 may be used in step 230.

If it is established in step 230 that the first vehicle identifier does not match the second vehicle identifier, the billing information is not provided. For example, in such a case, the billing information is not even determined in the first place. In particular, there is no transmission of billing information to the backend server 130. The energy costs for the transferred electrical energy, as indicated by the charging information, are then billed in a different way, for example, even though the charging apparatus 110 is still able to be used to charge the battery of the vehicle 120. In particular, the energy costs are then not billed to the employee's company.

Advantageously, steps 210 to 230 performed by the apparatus 150 make it possible for example to limit billing of the electricity costs for charging the vehicle 120 to the case in which such billing is also actually allowed for the vehicle 120. In such a case, the apparatus 150 communicates with a backend server 130 of the company so that the electricity costs are billed to said company. Otherwise, no communication with the backend server 130 and also no corresponding billing is performed, but the charging cable 160 is advantageously still able to be used to charge the vehicle 120.

By way of example, recognizing the vehicle 120 prevents cases of fraud in which an employee of a company attempts to bill the electricity costs for charging other vehicles, for which billing the electricity costs to the company is not allowed, to the company as well. In particular, recognition accordingly takes place based on the vehicle and not for example based on the user.

The apparatus 150 advantageously allows vehicle recognition for the purpose of billing regardless of whether the charging apparatus 110 technically supports vehicle recognition. By way of example, the charging apparatus 110 is a private charging station (for example an AC charging station or for example a power outlet) that for technical reasons does not support vehicle recognition because for example it does not, or not fully, support corresponding communication protocols (for example the ISO 15118 protocol) for communication between the charging station 110 and the vehicle 120. The described use of the apparatus 150 may advantageously enable recognition of a vehicle 120 and targeted billing regardless of the respective technical design of the charging apparatus 110.

FIG. 3 shows a flowchart of one exemplary embodiment of a method 300 according to the present disclosure. Method steps 310, 320 and 330 are described below by way of example with reference to the environment 100 shown in FIG. 1. It is assumed here by way of example that method steps 310, 320 and 330 are performed by the apparatus 150.

Step 310 comprises obtaining position information, wherein the position information indicates a position of the apparatus.

For example, in step 310, the apparatus 150 obtains the position information from a position sensor that is part of the apparatus 150 or is connected to the apparatus 150. Such a position sensor may be a GPS sensor that detects a current position of the position sensor and thus of the apparatus 150 and determines the position information based thereon, wherein the position information indicates the position of the apparatus 150 using multiple position coordinates.

Step 320 comprises determining whether the position of the apparatus is located within a predetermined position range.

For example, the apparatus 150 determines whether the position of the apparatus 150 as indicated by the position information obtained in step 310 is located within a predetermined position range. For this purpose, an electronic memory of the apparatus 150 may store position coordinates that reflect the predetermined position range (for example a geographical area). In step 320, the position coordinates that reflect the predetermined range are then compared with the position coordinates of the position information obtained in step 310.

As an alternative or in addition, the determination whether the position of the apparatus is located within a predetermined position range may be performed on the backend server 130. In such a case, as part of step 320, the apparatus 150 for example transfers the position information obtained in step 310 to the backend server 130, which compares this position information with the predetermined position range. For this purpose, position coordinates that reflect the predetermined position range are stored for example in an electronic memory of the backend server 130.

Step 330 comprises providing the billing information when it is additionally determined that the position of the apparatus is located within a predetermined position range.

For example, according to step 330, billing information is provided, as described for step 230 in FIG. 2, (for example only) when the first vehicle identifier matches the second vehicle identifier and when the position of the apparatus 150 is additionally located within a predetermined position range. A combination of these two conditions for the provision with further conditions is likewise conceivable.

The predetermined position range may in particular be understood to be a geographical area within which billing of the energy costs for charging the vehicle 120 is allowed. Steps 310 to 330 advantageously for example provide a further security feature in order to prevent cases of fraud involving unauthorized billing of electricity costs for charging electric vehicles to a company.

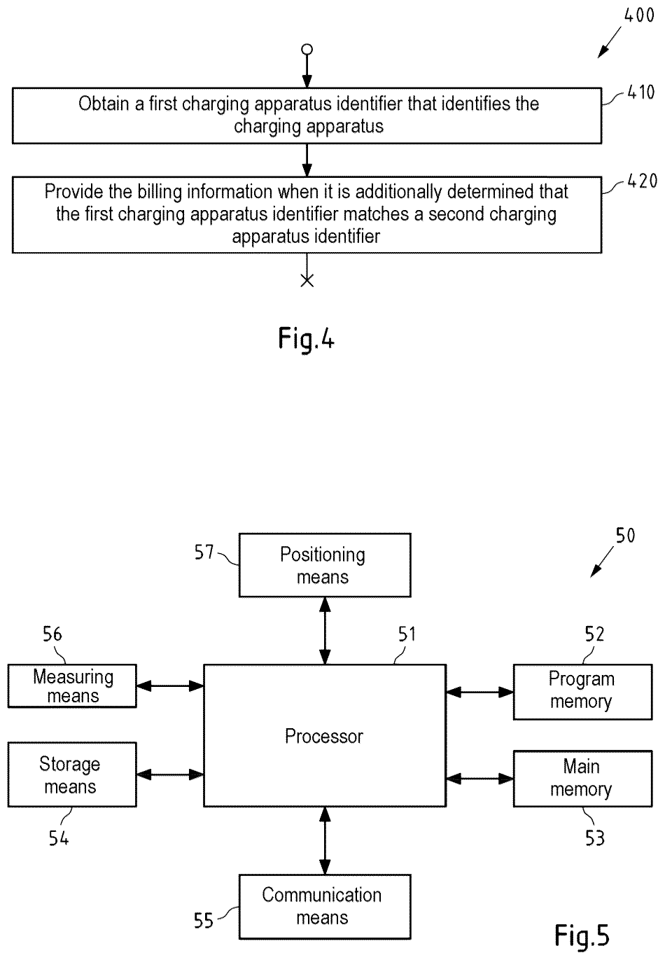

FIG. 4 shows a flowchart of one exemplary embodiment of a method 400 according to the present disclosure. Method steps 410 and 420 are described below by way of example with reference to the environment 100 shown in FIG. 1. It is assumed here by way of example that method steps 410 and 420 are performed by the apparatus 150.

Step 410 comprises obtaining a first charging apparatus identifier that identifies the charging apparatus.

For example, in step 410, the apparatus 150 obtains the first charging apparatus identifier from the charging apparatus 110, wherein the first charging apparatus identifier identifies the charging apparatus 110. The first charging apparatus identifier is in this case transferred in particular from the charging apparatus 110 to the apparatus 150 via the cable section 140b of the charging cable 160. By way of example, the transfer may be performed in accordance with the ISO 15118 protocol, wherein the first charging apparatus identifier may be the “Charge Point Identifier (CPID)”. However, the transfer of the charging apparatus identifier in step 410 is not tied to a specific protocol, meaning that for example the charging apparatus 110 does not have to support the ISO 15118 protocol.

Step 420 comprises providing the billing information when it is additionally determined that the first charging apparatus identifier matches a second charging apparatus identifier.

For example, according to step 420, billing information is provided, as described for step 230 in FIG. 2, (for example only) when the first vehicle identifier matches the second vehicle identifier and when the first charging apparatus identifier additionally matches a second charging apparatus identifier.

For example, the apparatus 150 determines whether the first charging apparatus identifier obtained from the charging apparatus 110 in step 410 matches a second charging apparatus identifier that is stored in an electronic memory of the apparatus 150. Such a match is present for example when the first charging apparatus identifier is the same as the second charging apparatus identifier or when the first charging apparatus identifier and the second charging apparatus identifier identify the same charging apparatus. As an alternative or in addition, the determination whether the first charging apparatus identifier matches the second charging apparatus identifier may be performed on the backend server 130. In such a case, as part of step 420, the apparatus 150 for example transfers the first charging apparatus identifier obtained in step 410 to the backend server 130, which compares the first charging apparatus identifier with a second charging apparatus identifier. For this purpose, the second charging apparatus identifier is stored for example in an electronic memory of the backend server 130.

For example, the second charging apparatus identifier identifies a specific charging apparatus for which separate billing of the electrical energy for charging a battery of a vehicle is permitted to be performed. According to the above description for FIG. 1, the second charging apparatus identifier may for example identify a private charging station of an employee of a company for which the employee is allowed to have the costs of charging the electric battery of a vehicle (for example the vehicle 120) billed to the company.

Steps 410 and 420 advantageously for example provide a further security feature in order to prevent cases of fraud involving unauthorized billing of electricity costs for charging electric vehicles to a company.

With reference to FIG. 2, FIG. 3 and FIG. 4, a combination of multiple conditions for providing billing information is also possible. By way of example, there may thus be a combination of the conditions from step 330 and step 420, such that provision of billing information is performed in step 230 (for example only) when i) the first vehicle identifier matches the second vehicle identifier, when ii) the position of the apparatus 150 is additionally located within a predetermined position range and when iii) the first charging apparatus identifier additionally matches a second charging apparatus identifier.

FIG. 5 shows a schematic illustration of one exemplary embodiment of the apparatus according to the present disclosure. By way of example, the apparatus 50 may be understood to be the apparatus 150 shown in FIG. 1. In another example, the apparatus 50 may be understood to be part of the apparatus 150.

The apparatus 50 comprises, by way of example, a processor 51. A processor should be understood to mean for example a microprocessor, a microcontrol unit, a microcontroller, a digital signal processor (DSP), an application-specific integrated circuit (ASIC) or a field-programmable gate array (FPGA). It goes without saying that the apparatus 50 may also comprise multiple processors 51.

The processor 51 executes program instructions that are stored in a program memory 52, and stores for example intermediate results or the like in a main memory 53. The program memory 52 contains for example program instructions of a computer program according to the present disclosure that comprises program instructions that cause the processor 51 to perform and/or control the method according to the present disclosure (for example the method 200 according to FIG. 2) when the processor 51 executes the program instructions stored in the program memory 52.

The program memory 52 further contains for example an operating system of the apparatus 50, which operating system is at least partially loaded into the main memory 53, when the apparatus 50 is started, and is executed by the processor 51. In particular, at least part of the core of the operating system is loaded into the main memory 53, when the apparatus 50 is started, and is executed by the processor 51.

One example of an operating system is a Windows, UNIX, Linux, Android, Apple iOS and/or MAC OS operating system. The operating system allows in particular the use of the apparatus 50 for data processing. It manages for example resources such as the program memory 52 and the main memory 53 and provides other computer programs with fundamental functions, inter alia by way of programming interfaces, and controls the execution of computer programs.

A program memory is for example a non-volatile memory such as a flash memory, a magnetic memory, an EEPROM memory (electrically erasable programmable read-only memory) and/or an optical memory. A main memory is for example a volatile or non-volatile memory, in particular a random access memory (RAM) such as a static RAM memory (SRAM), a dynamic RAM memory (DRAM), a ferroelectric RAM memory (FeRAM) and/or a magnetic RAM memory (MRAM).

The apparatus 50 may additionally comprise the storage means 54, wherein the processor 51 is for example connected to the storage means 54 such that electronic information is able to be stored in the storage means 54 by the apparatus 50 or is able to be retrieved from the storage means 54 by the apparatus 50. The storage means 54 may for example comprise an electronic memory in which the apparatus 50 is able to store electronic information such as for example one or more vehicle identifiers, items of billing information, items of charging information, charging apparatus identifiers and/or items of position information. The storage means 54 may be understood for example to be a separate electronic memory, or also be part of the program memory 52 or main memory 53.

The apparatus 50 may additionally comprise the communication means 55, wherein the processor 51 is for example connected to the communication means 55 such that electronic information is able to be sent or received by the apparatus 50 via the communication means 55. With regard to the apparatus 150 in FIG. 1, the communication means 55 are for example configured to provide the communication connection 170. For example, the communication means 55 comprise a radio interface for communication in accordance with a mobile radio standard (for example the 3G, 4G or 5G standard) or in accordance with another wireless radio communication technology (for example Wi-Fi). As an alternative or in addition, the communication means comprise an interface for communication in accordance with a wired technology (for example USB or Ethernet).

The apparatus 50 may additionally comprise the measuring means 56, wherein the processor 51 is for example connected to the measuring means 56 such that electronic information (for example charging information) is able to be determined by the measuring means 56 and then transferred to the apparatus 50. The measuring means 56 comprise for example an electricity meter that is configured, with regard to the apparatus 150 in FIG. 1, to detect (for example measure) the electrical energy transferred from the charging apparatus 110 to the vehicle 120 via the charging cable 160. Such an electricity meter comprises for example multiple electronic components, such as a transducer, an analog-to-digital converter, a processor and/or an internal electronic memory.

The apparatus 50 may additionally comprise the positioning means 57, wherein the processor 51 is for example connected to the positioning means 57 such that electronic information (for example position information) is able to be determined by the positioning means 57 and then transferred to the apparatus 50. The positioning means comprise for example one or more satellite positioning sensors (for example a GPS sensor) in order to detect the position coordinates of the apparatus 50 at a certain time. As an alternative or in addition, the positioning means 57 are able to determine a position of the apparatus 50 for example by radio triangulation (for example based on mobile radio signals received by a radio interface of the communication means 55).

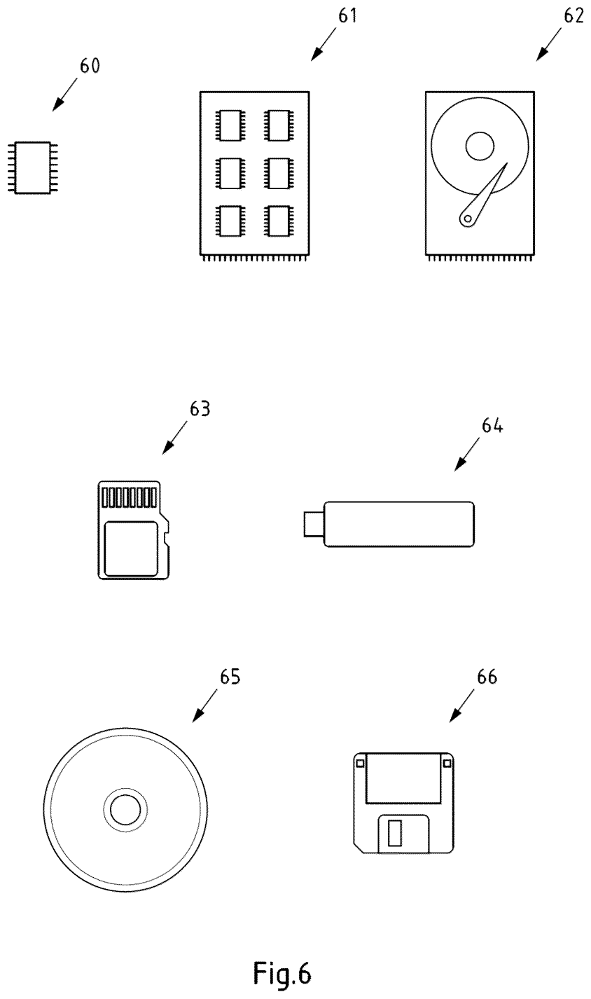

FIG. 6 shows exemplary embodiments of storage media on which for example a computer program according to the present disclosure may be stored. The storage medium may be for example a magnetic, electrical, optical and/or other storage medium. The storage medium may for example be part of a processor (for example the processor 51 in FIG. 5), for example a (non-volatile or volatile) program memory of the processor or part thereof (for example program memory 52 in FIG. 5). Exemplary embodiments of a storage medium are a flash memory 60, an SSD hard disk 61, a magnetic hard disk 62, a memory card 63, a memory stick 65 (for example a USB stick), a CD-ROM or DVD 65 or a floppy disk 66.

The exemplary embodiments of the present disclosure that are described in this specification should also be understood to be disclosed in all combinations with one another. In particular, the description of a feature that an embodiment comprises should also not-unless explicitly stated to the contrary—be understood in the present case to mean that the feature is indispensable or essential for the function of the exemplary embodiment. The sequence of the method steps outlined in this disclosure in the individual flowcharts is not mandatory; alternative sequences of the method steps are conceivable-unless indicated otherwise. The method steps may be implemented in various ways, and so implementation using software (by way of program instructions), hardware or a combination of the two is conceivable for implementing the method steps.

Terms used in the patent claims such as “comprise”, “have”, “include”, “contain” and the like do not exclude further elements or steps. The wording “at least partially” encompasses both the “partially” case and the “completely” case. The wording “and/or” should be understood to the effect that both the alternative and the combination are intended to be disclosed, that is to say that “A and/or B” means “(A) or (B) or (A and B)”. In the context of this specification, a plurality of units, persons or the like means multiple units, persons or the like. The use of the indefinite article does not exclude a plurality. A single device may perform the functions of a plurality of units or devices mentioned in the patent claims. Reference signs indicated in the patent claims should not be regarded as limitations for the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An apparatus comprising means configured to:
obtain charging information, wherein the charging information indicates an electrical energy transferred from a charging apparatus to a vehicle;
obtain a first vehicle identifier that identifies the vehicle;
provide billing information when it is determined that the first vehicle identifier matches a second vehicle identifier, wherein the billing information represents at least the electrical energy transferred to the vehicle.

2. The apparatus according to claim 1, wherein the means of the apparatus are further configured to determine whether the first vehicle identifier matches the second vehicle identifier.

3. The apparatus according to claim 1, wherein the billing information further identifies the vehicle, and wherein billing of the electrical energy transferred to the vehicle is performed at least partially based on the vehicle identified by the billing information.

4. The apparatus according to claim 1, further comprising storage means, wherein the storage means are configured to store a plurality of vehicle identifiers comprising the second vehicle identifier.

5. The apparatus according to claim 1, further comprising communication means, wherein the communication means are configured to transfer the provided billing information to a backend server.

6. The apparatus according to claim 1, further comprising measuring means, wherein the measuring means are configured to detect the electrical energy transferred to the vehicle and to determine the charging information.

7. The apparatus according to claim 1, further comprising connecting means, wherein the connecting means are configured to connect the apparatus to the vehicle and the apparatus to the charging apparatus.

8. The apparatus according to claim 1, wherein the means are further configured to receive the first vehicle identifier from the vehicle.

9. The apparatus according to claim 1, wherein the means are further configured to
obtain position information, wherein the position information indicates a position of the apparatus;
determine whether the position of the apparatus is located within a predetermined position range; and
provide the billing information when it is additionally determined that the position of the apparatus is located within a predetermined position range.

10. The apparatus according to claim 9, further comprising positioning means, wherein the positioning means are configured to detect the position of the apparatus and to determine the position information.

11. The apparatus according to claim 1, wherein the means are further configured to
obtain a first charging apparatus identifier that identifies the charging apparatus; and
provide the billing information when it is additionally determined that the first charging apparatus identifier matches a second charging apparatus identifier.

12. The apparatus according to claim 11, wherein the means of the apparatus are further configured to determine whether the first charging apparatus identifier matches the second charging apparatus identifier.

13. The apparatus according to claim 11, further comprising storage means, wherein the storage means are configured to store a plurality of charging apparatus identifiers comprising the second charging apparatus identifier.

14. The apparatus according to claim 1, wherein the apparatus is at least part of a charging cable for charging an electrical storage unit of the vehicle or wherein the apparatus is connectable to a charging cable for charging an electrical storage unit of the vehicle.

15. A method comprising:
obtaining charging information, wherein the charging information indicates an electrical energy transferred from a charging apparatus to a vehicle;
obtaining a first vehicle identifier that identifies the vehicle;
providing billing information when it is determined that the first vehicle identifier matches a second vehicle identifier, wherein the billing information represents at least the electrical energy transferred to the vehicle.

16. A computer program comprising commands that cause an apparatus to perform the method steps according to claim 15.
